(19) United States
(12) Patent Application Publication
(10) Pub. No.: US 2016/0307415 A1
(43) Pub. Date: Oct. 20, 2016

(54) APPARATUS, SYSTEM AND METHOD FOR MONITORING A DEVICE WITHIN A ZONE

(71) Applicant: Sennco Solutions, Inc., Plainfield, IL (US)

(72) Inventors: Christopher Marszalek, Plainfield, IL (US); Daniel Horvath, Plainfield, IL (US); Andy Reynolds, Aurora, IL (US); Rebecca Regan, Elk Grove Village, IL (US); Dale Russell Liff, Kent, OH (US); Stephen Michael Strom, North Olmsted, OH (US)

(73) Assignee: Sennco Solutions, Inc., Plainfield, IL (US)

(21) Appl. No.: 14/689,660

(22) Filed: Apr. 17, 2015

(51) Int. Cl. G08B 13/14; G08B 25/10

(52) U.S. Cl. CPC G08B 13/1427; G08B 25/10

(57) ABSTRACT

An apparatus, a system and a method monitor a device within a zone. A head may wirelessly communicate with an emitter and a hub. The device may be secured to the head. The emitter may transmit a signal to define the zone, and the head may receive the signal to detect the presence of the device and the head within the zone. A first alarm may be triggered upon removal of the head and the device from the zone. A second alarm may be triggered upon removal of the head and the device from the zone for a time that exceeds a threshold of time. A key may insert into the hub to deactivate the second alarm.

### BACKGROUND OF THE INVENTION

The present invention generally relates to an apparatus, a system and/or a method for monitoring a device. The apparatus, the system, and/or the method may deter theft of the device and/or removal of the device. The apparatus, the system, and the method may allow the device to be used by an individual.

Generally, an individual prefers to use a device before buying the same. The device may be on display and/or for sale, for example, in a retail environment. The device may be a portable electronic device, such as, for example, a cellular telephone, a tablet computer, a laptop computer, a camera, a camcorder, a digital camera, a digital music player, a digital video player, a digital video recorder, a personal data assistant, an E-book, an E-reader and/or the like. Using the device may cause security concerns, such as theft and/or misappropriation of the device.

Known security systems may allow the individual to use the device while the device may be secured. The known security systems may secure the device to a display via a security tether, such as a cable. The display may be electronically connected by a cable to a sensor that may be attached to the device. The connection of the cable may be used to power the device and/or communicate with an alarm. The known security systems may alert the individual that the alarm has been triggered upon disconnection of the cable. Traditionally, while using the device secured by the known security systems, the device remains tethered to the display by the cable. As a result, the individual may be unable to use the device independent of the cable and/or the display. In addition, the known security systems may prevent the individual from examining characteristics of the device, such as, for example, its weight, its feel, and/or its portability. For example, known security systems may prevent the individual from placing the device in a pocket, a backpack, a purse and/or the like, to determine whether the device is suitable to the individual.

A need, therefore, exists for an apparatus, a system and/or a method for monitoring a device within a zone. Additionally, a need exists for an apparatus, a system and/or a method for monitoring a device within a zone which may allow the individual to use the device within a distance from a display of the device. Moreover, a need exists for an apparatus, a system and/or a method for monitoring a device within a zone which may use wireless communication to monitor the device. Further, a need exists for an apparatus, a system and/or a method for monitoring a device within a zone which may trigger an alarm that may alert the individual that the device may be outside of the zone.

### SUMMARY OF THE INVENTION

The present invention generally relates to an apparatus, a system and/or a method for monitoring a device within a zone. Further, the apparatus, the system and/or the method for monitoring the device within the zone may have a hub, a head and/or an emitter.

To this end, in an embodiment of the present invention, an apparatus for monitoring a first device within a first zone wherein the first device may be inside of the first zone in a first position and further wherein the first device may be outside of the first zone in a second position is provided. The apparatus may have a first emitter, a first head and a hub. The first emitter may be within the first zone and may have a first transmitter that may transmit a first signal to establish the first zone that may extend from the first emitter. The first head may be secured to the first device wherein the first head may wirelessly communicate with the first emitter. The first head may have a first receiver that may receive the first signal in the first position of the first device. The first head may trigger a first alarm in the second position of the first device. The first head may have a second transmitter that may transmit a second signal in the second position of the first device. The hub may wirelessly communicate with the first emitter and the first head wherein the hub may have a second receiver that may receive the second signal and further wherein the hub may trigger a second alarm in the second position of the first device.

In an embodiment, the apparatus may have a light associated with the first head wherein the light may emit a visible alert.

In an embodiment, the apparatus may have a second emitter within a second zone and may have a third transmitter that may transmit a third signal that may establish the second zone that may extend from the second emitter wherein the first head and the hub may wirelessly communicate with the second emitter.

In an embodiment, the apparatus may have a key that may insert into the hub to deactivate the second alarm.

In an embodiment, the apparatus may have a second head that may be secured to a second device wherein the second head may wirelessly communicate with the first emitter and the hub.

In an embodiment, the apparatus may have a speaker in the hub wherein the speaker may emit an audible alert.

In an embodiment, the apparatus may have a cable that may have a length defined between a first end and a second end wherein the first end may be connected to the first device and the second end may be connected to the first head.

In another embodiment of the present invention, a system for monitoring a first device within a first zone wherein an alarm may be triggered that may indicate that the first device may be removed to a position outside of the first zone is provided. The system may have a first emitter and a first head. The first emitter may have a first receiver that may receive a first signal and a first transmitter that may transmit a second signal that may establish the first zone that may extend from the first emitter. The first head may be secured to the first device wherein the first head may wirelessly communicate with the first emitter and may receive the second signal and further wherein the first head may trigger the first alarm.

In an embodiment, the system may have a second head that may be secured to a second device wherein the second head may wirelessly communicate with the first emitter and may receive the second signal and further wherein the second head may trigger an alert that may be indicative of the second device in a position outside of the first zone.

In an embodiment, the system may have a hub that may wirelessly communicate with the first emitter and the first head wherein the first head may transmit a third signal to the hub and further wherein the third signal may be indicative of the first device in the position outside of the first zone.

In an embodiment, the system may have a cradle that may be within the first zone and may have a recess wherein the first head may rest in the recess.

In an embodiment, the system may have a second emitter that may have a second receiver and a second transmitter wherein the second emitter may wirelessly communicate with the first head and may establish a second zone and further wherein the second zone may intersect with the first zone.

In an embodiment, the system may have a speaker that may be in the first head wherein the speaker may emit an audible alert.

In another embodiment of the present invention, a method for monitoring a device within a zone wherein the device may wirelessly communicate with a first emitter and a hub and further wherein the zone may surround the first emitter is provided. The method may have the step of transmitting a first signal wirelessly from the hub to the first emitter. The method may have the step of transmitting a second signal wirelessly from the first emitter to define the zone. The method may have the step of detecting the device in a position exterior to the zone. The method may have the step of triggering a first alarm upon detection of the device in the position exterior to the zone.

In an embodiment, the method may have the step of deactivating the first alarm upon detection of the device in a position within the zone.

In an embodiment, the method may have the step of transmitting a third signal wirelessly from the device to the hub wherein the third signal is indicative of a detection of the device in the position exterior to the zone.

In an embodiment, the method may have the step of triggering a second alarm indicative of the device in the position exterior to the zone.

In an embodiment, the method may have the step of disarming the second alarm by inserting a key into the hub.

In an embodiment, the method may have the step of illuminating a light in response to triggering the first alarm.

In an embodiment, the method may have the step of transmitting the first signal wirelessly from the hub to a second emitter that is in wireless communication with the hub and the device.

It is, therefore, an advantage of the present invention to provide an apparatus, a system and/or a method for monitoring a device within a zone.

Another advantage of the present invention is to provide an apparatus, a system and/or a method that may be used to deter theft of the device and/or removal of the device from the zone.

Further, an advantage of the present invention is to provide an apparatus, a system and/or a method for monitoring a device within a zone that may use wireless communication to monitor the device.

Moreover, an advantage of the present invention is to provide an apparatus, a system and/or a method for monitoring a device within a zone which may allow the device to be handled by an individual.

Yet another advantage of the present invention is to provide an apparatus, a system and/or a method for monitoring a device within a zone that may use a radio frequency signal to create the zone.

Further, an advantage of the present invention is to provide an apparatus, a system and/or a method for monitoring a device within a zone that may trigger an alarm upon removal of the device.

Another advantage of the present invention is to provide an apparatus, a system and/or a method for monitoring a device within a zone that may trigger an alarm upon removal of the device for a time that exceeds a threshold.

Yet another advantage of the present invention is to provide an apparatus, a system and/or a method for monitoring a device within a zone that may have a key that may insert into a hub to deactivate an alarm.

Moreover, an advantage of the present invention is to provide an apparatus, a system and/or a method that may monitor more than one device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a system for monitoring a device within a zone in an embodiment of the present invention.

FIG. 2 illustrates a perspective view of a head, an emitter, a hub and a display for monitoring a device within a zone in an embodiment of the present invention.

FIG. 3 illustrates a perspective view of a head, an emitter, a hub and a display for monitoring a device within a zone in an embodiment of the present invention.

FIG. 4 illustrates a perspective view of a hub and a key for monitoring a device within a zone in an embodiment of the present invention.

FIG. 5 illustrates a perspective view of a head for monitoring a device within a zone in an embodiment of the present invention.

FIG. 6. illustrates a perspective view of a head, a hub and an emitter for monitoring a device within a zone in an embodiment of the present invention.

FIG. 7 illustrates a black box diagram of a hub for monitoring a device within a zone in an embodiment of the present invention.

FIG. 8 illustrates a black box diagram of a head for monitoring a device within a zone in an embodiment of the present invention.

FIG. 9 illustrates a black box diagram of an emitter for monitoring a device within a zone in an embodiment of the present invention.

FIG. 10 illustrates a perspective view of a head, multiple emitters, a hub and a display for monitoring a device within multiple zones in an embodiment of the present invention.

FIG. 11 illustrates a perspective view of a head, multiple emitters, a hub and a display for monitoring a device within multiple zones in an embodiment of the present invention.

### DETAILED DESCRIPTION OF THE PRESENTLY PREFERRED EMBODIMENTS

The present invention generally relates to a system and/or a method for monitoring a device. The apparatus, the system and/or the method may monitor a device within a zone via an emitter, a head and/or a hub. The emitter, the head and/or the hub may be in wireless communication. The head may have an adhesive for attaching the device to the head. The apparatus, the system and/or the method may deter removal of the device. The apparatus, the system and/or the method may allow an individual to use the device within a distance from a display of the device. The apparatus, the system and/or the method may trigger an alarm upon removal of the head and/or the device.

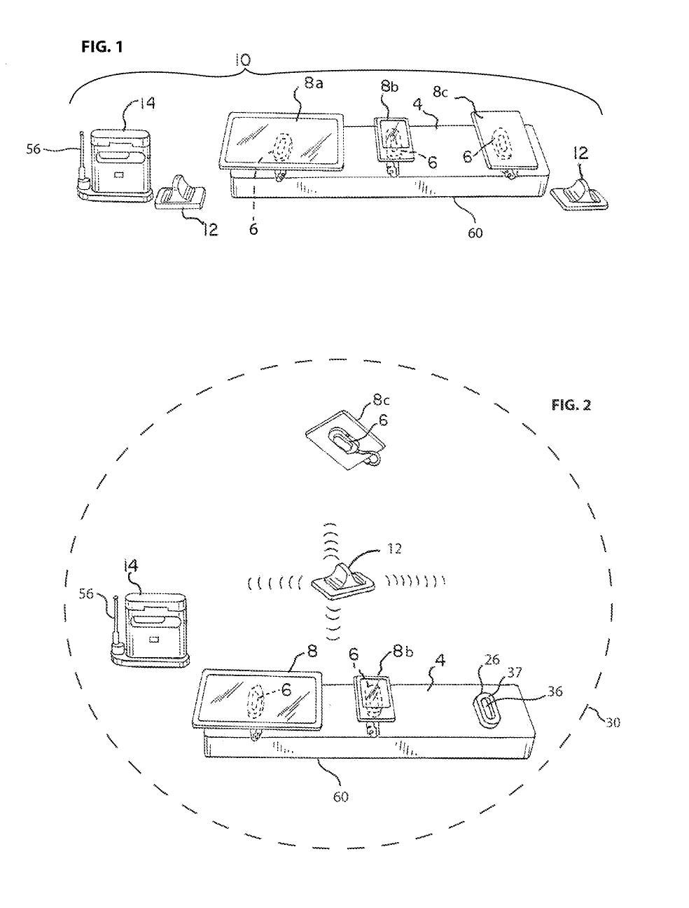

Referring now to the drawings wherein like numerals refer to like parts, FIG. 1 illustrates a system 10 which may monitor a device 8a, a device 8b and/or a device 8c (hereinafter collectively and individually referred to as “the device 8”) in an embodiment of the present invention. The device 8 may be on display and/or for sale, for example, in a retail environment. The device 8 may be a portable electronic device, such as, for example, a cellular telephone, a tablet or a laptop computer, a camera, a camcorder, a digital camera, a digital music player, a digital video player, a digital video recorder, a personal data assistant, an E-book, an E-reader and/or the like. The present invention should not be deemed as limited to a specific embodiment of the device 8. It should be understood that the device 8 may be any device that may be displayed and/or for sale in a retail environment as known to one having ordinary skill in the art.

In addition, as shown in FIG. 1, the system 10 may have a hub 14, one or more heads 6 and/or one or more emitters 12. The head 6, the emitter 12 and/or the hub 14 may be constructed from a material, such as, for example, plastic, thermoplastic, silicone, rubber, metal and/or the like and/or a combination thereof. The present invention should not be deemed as limited to a specific embodiment of the material of the head 6, the emitter 12 and/or the hub 14. It should be understood that the head 6, the emitter 12 and/or the hub 14 may be constructed from any material as known to one having ordinary skill in the art. The head 6 may be secured to the device 8. For example, an adhesive and/or the like may secure the head 6 to the device 8. The head 6 may have a top surface 17, as illustrated in FIG. 5. In addition, the device 8 may have a bottom surface 9, as illustrated in FIG. 5. The top surface 17 of the head 6 may be secured to the bottom surface 9 of the device 8.

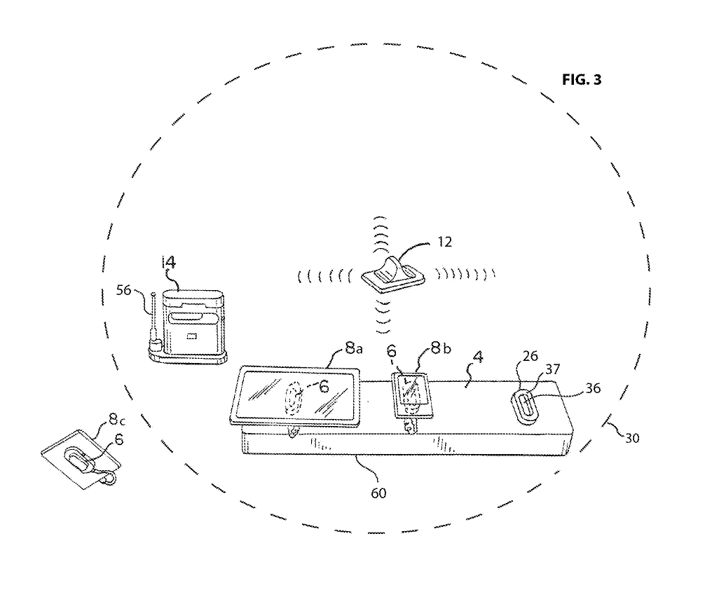

As illustrated in FIG. 1, in an embodiment of the present invention, the system 10 may have a display 60 for the device 8. The display 60 may have a base 4 and/or a cradle 26. The base 4 may be connected to the cradle 26 by, for example, screws, retaining clips, adhesive and/or the like. The cradle may have a recess 36 and/or a top surface 37, as illustrated in FIGS. 2, 3, 10 and 11. The recess 36 may extend in an inward direction with respect to the top surface 37. The head 6 may have a projection 46 and/or a bottom surface 47, as illustrated in FIG. 5. The projection 46 may extend in an outward direction with respect to the bottom surface 47 of the head 6. The recess 36 may be sized to fit the projection 46 so that the head 6 and/or the device 8 may be docked on the display 60 in a first position of the head 6, as shown in FIG. 1. In the first position of the head 6, the top surface 37 of the cradle 26 may be in contact with the bottom surface 47 of the head 6. As shown in FIGS. 2, 3, 10 and 11, in a second position of the head 6, the head 6 and/or the device 8 may not be in contact the display 60.

As shown in FIG. 6, the head 6 may wirelessly communicate with the emitter 12 and/or the hub 14. For example, the head 6, the emitter 12 and/or the hub 14 may use radio signals that may allow for wireless communication between the head 6, the emitter 12 and/or the hub 14. The radio signals may be, for example, high frequency and/or low frequency. The emitter 12 may wirelessly communicate with the hub 14 to transmit the radio signals that may establish a zone 30 that may extend from the emitter 12. As shown in FIGS. 2, 3, 10 and 11 the zone 30 may surround and/or be adjacent to the display 60 of the device 8. Movement of the head 6 and/or device 8 may be permitted within the zone 30. Removing the head 6 and/or the device 8 from the zone 30 may trigger a first alarm.

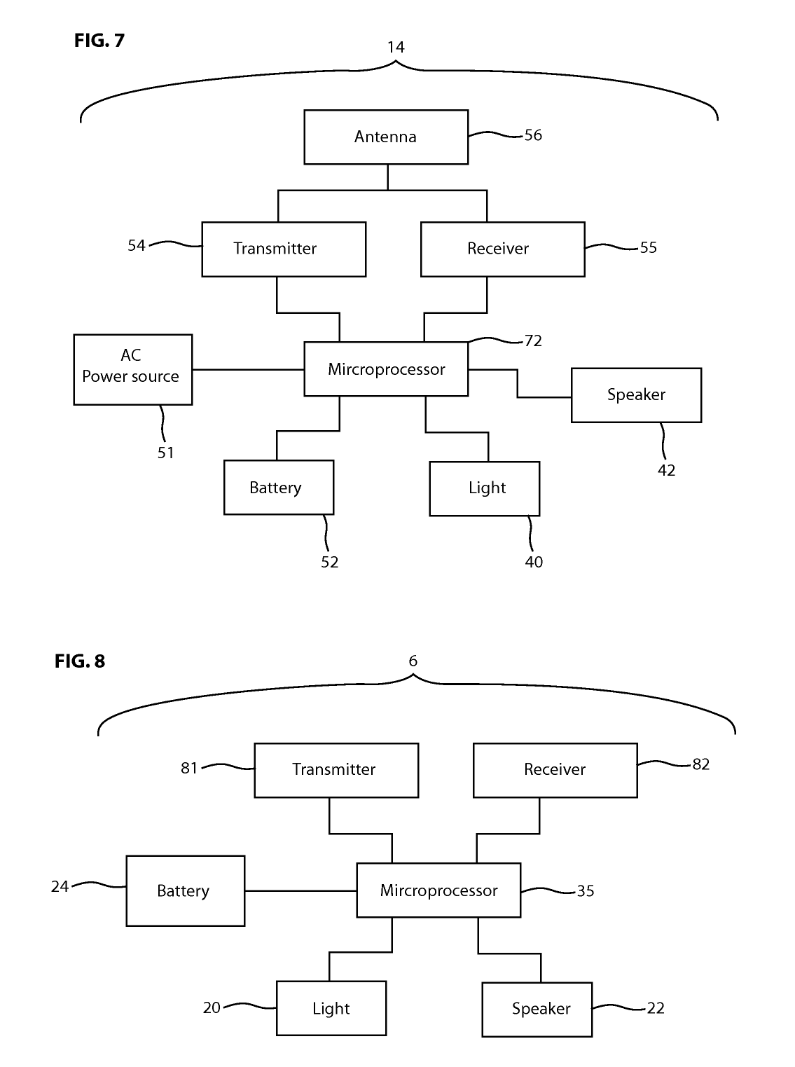

As illustrated in FIG. 7, the hub 14 may have a microprocessor 72 that may be housed within the hub 14 and/or secured to the hub 14. The microprocessor 72 and/or the hub 14 may be connected to an AC power source 51 and/or may be powered by the AC power source 51. For example, the AC power source 51 may be an AC power adapter that may be connected to an AC power outlet. In an embodiment of the present invention, the microprocessor 72 and/or the hub 14 may be powered by a battery 52. The microprocessor 72 may be programmed to wirelessly communicate with the head 6 and/or the emitter 12. A transmitter 54 may be connected to and/or controlled by the microprocessor 72. The transmitter 54 may wirelessly communicate with the head 6 and/or the emitter 12. The transmitter 54 may, for example, transmit signals to the head and/or the emitter 12. Further, a receiver 55 may be connected to the microprocessor 72. The receiver 55 may wirelessly communicate with the head 6 and/or the emitter 12. For example, the receiver 55 may receive signals that may be transmitted by the head 6 and/or the emitter 12. The hub 14 may have an antenna 56 that may send and/or receive signals.

As illustrated in FIG. 8, the head 6 may have a microprocessor 35 in an embodiment of the present invention. The microprocessor 35 may be housed within the head 6 and/or secured to the head 6. The microprocessor 35 may be programmed to wirelessly communicate with the emitter 12 and/or the hub 14. A transmitter 81 may be connected to and/or controlled by the microprocessor 35. The transmitter 81 may wirelessly communicate with the emitter 12 and/or the hub 14. The transmitter 81 may, for example, transmit signals to the emitter 12 and/or hub 14. Further, a receiver 82 may be connected to the microprocessor 35. The receiver 82 may wirelessly communicate with the emitter 12 and/or the hub 14. For example, the receiver 82 may receive signals that may be transmitted by the head 6 and/or the emitter 12.

Further, the microprocessor 35 may, for example, be programmed to determine that the head 6 and/or the device 8 may be located within and/or outside of the zone 30. For example, the microprocessor 35 may be programmed to determine that the head 6 and/or the device 8 may be within the zone 30 when the receiver 82 may receive radio signals from the emitter 12. In addition, for example, the microprocessor 35 may be programmed to determine that the head 6 and/or the device 8 may be located outside of the zone 30 when the receiver 82 fails to receive radio signals from the emitter 12.

As illustrated in FIG. 8, the head 6 may have a battery 24 that may be housed within the head 6 and/or may be secured to the head 6. The battery 24 may be, for example, a rechargeable battery. The battery 24 may be connected to the microprocessor 35 and/or may power the microprocessor 35. In addition, the battery 24 may provide power to the device 8 through a cable 84, as illustrated in FIG. 5. The cable 84 may have a length defined between a first end 85 and/or a second end 86. The first end 85 of the cable 84 may have a first plug 95 for connecting the cable 84 the head 6. The first plug 95 may be, for example, a USB plug and/or the like. The second end 86 of the cable 84 may have a second plug 96 for connecting the cable 84 to the device 8. The second plug 96 may be a USB plug and/or the like.

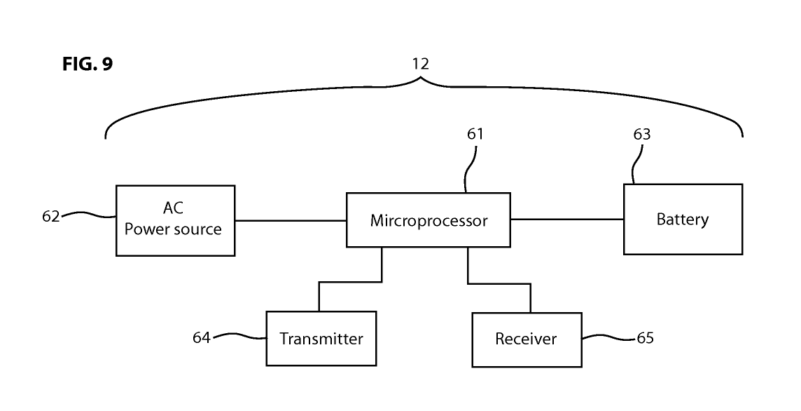

As illustrated in FIG. 9, the emitter 12 may have a microprocessor 61 that may be housed within the emitter 12 and/or secured to the emitter 12. The microprocessor 61 may be connected to an AC power source 62 and/or may be powered by the AC power source 62. For example, the AC power source 62 may be an AC power adapter that may be connected to an AC power outlet. In an embodiment of the present invention, the microprocessor 61 and/or the emitter 12 may be powered by a battery 63. The microprocessor 61 may be programmed to wirelessly communicate with the head 6 and/or the hub 14. A transmitter 64 may be connected to and/or controlled by the microprocessor 61. The transmitter 64 may wirelessly communicate with the head 6 and/or the hub 14. The transmitter 64 may, for example, transmit signals to the head 6 and/or the emitter 12. Further, a receiver 65 may be connected to the microprocessor 72. The receiver 65 may wirelessly communicate with the head 6 and/or the hub 14. For example, the receiver 65 may receive signals that may be transmitted by the head 6 and/or the emitter 12.

As illustrated in FIG. 6, the hub 14 may transmit a signal 15 to the emitter 12. The signal 15 may be, for example, a high frequency radio signal. The emitter 12 may receive the signal 15 from the hub 14. After receiving the signal 15 from the hub 14, the emitter 12 may wirelessly transmit a signal 13 that may be, for example, a low frequency radio signal. The emitter 12 may transmit the signal 13 to define the zone 30 that may extend from the emitter 12. As illustrated in FIGS. 2, 3, 10 and 11, the zone 30 may extend a distance from the emitter 12 and/or may surround the display 60. For example, the zone 30 may extend five feet to ten feet from the emitter 12.

Upon removal of the head 6 and/or the device 8 from the zone 30, the head 6 may trigger a first alarm that may be a first audible signal and/or a first visible signal. The first audible signal and/or the first visible signal may alert the individual to return the head 6 and/or the device 8 to the zone 30. As illustrated in FIGS. 5 and 8, the head 6 may have a light 20 that may be housed within the head 6 and/or may be secured to the head 6. In addition, the light 20 may be connected to the microprocessor 35 and/or may be controlled by the microprocessor 35. The light 20 may be, for example, a light-emitting diode (“LED”) and/or the like. The light 20 may be powered by the battery 24. The light 20 may emit the first visible signal to alert the individual that the first alarm may be triggered. For example, the light 20 may illuminate upon removal of the head 6 and/or the device 8 from the zone 30. The first alarm may be deactivated when the receiver 82 may receive the signal 13 from the emitter 12 and/or the microprocessor 35 determines that the head 6 and/or the device 8 may be located within the zone 30. Deactivation of the first alarm may indicate that the head 6 and/or the device 8 may be located within the zone 30. For example, the light 20 may turn off when the receiver 82 may receive the signal 13 and/or the microprocessor 35 determines that the head 6 and/or the device 8 may be located within the zone 30.

Moreover, as illustrated in FIGS. 5 and 8, the head 6 may have a speaker 22 that may be housed within the head 6 and/or may be secured to the head. The speaker 22 may be connected to the microprocessor 35 and/or may be controlled by the microprocessor 35. In addition, the speaker 22 may be powered by the battery 24. The speaker 22 may provide the first audible signal to alert the individual that the first alarm may be triggered. For example, the speaker 22 may emit the first audible signal upon removal of the head 6 and/or the device 8 from the zone 30. The speaker 22 may turn off when the receiver 82 may receive the signal 13 and/or the microprocessor 35 determines that the head 6 and/or the device 8 may be located within the zone 30.

The microprocessor 35 may be programmed to detect an absence of the signal 13. When the microprocessor 35 detects the absence of the signal 13 for a time that exceeds a threshold of time, the head 6 may transmit a signal 7 to the hub 14. The signal 7, for example, may be a high frequency signal. The threshold, for example, may be ten seconds. When the hub 14 receives the signal 7, a second alarm may be triggered. For example, if the head 6 and/or the device 8 may be located in a position outside of the zone 30 for greater than ten seconds, then the head 6 may transmit the signal 7 to the hub 14 and/or the hub 14 may trigger the second alarm. The second alarm may be a second audible signal and/or a second visible signal. The second alarm may alert, for example, the individual and/or a retail store employee that the head 6 and/or the device 8 has been removed from the zone 30 for the time that exceeds the threshold.

As illustrated in FIG. 7, the hub 14 may have a light 40 that may be housed within the hub 14 and/or may be secured to the hub 14. The light 40 may be powered by the AC power source 51 and/or the battery 52 of the hub 14. The light 40 may be, for example, a light-emitting diode (“LED”) and/or the like. The light 40 may emit the second visible signal to alert, for example, the retail store employee that the second alarm may be triggered. For example, the light 40 may illuminate upon removal of the head 6 and/or the device 8 from the zone 30 for the time that exceeds the threshold.

Moreover, as illustrated in FIG. 7, the hub 14 may have a speaker 42 that may be housed within the hub 14 and/or may be secured to the hub 14. The speaker 42 may be powered by the AC power source 51 and/or the battery 52 of the hub 14. The speaker may be connected to the microprocessor 72 and/or may be controlled by the microprocessor 72. The speaker 42 may emit the second audible signal to alert, for example, the retail store employee that the second alarm may be triggered. For example, the speaker 42 may emit the second audible signal upon removal of the head 6 and/or the device 8 from the zone 30 for the time that exceeds the threshold.

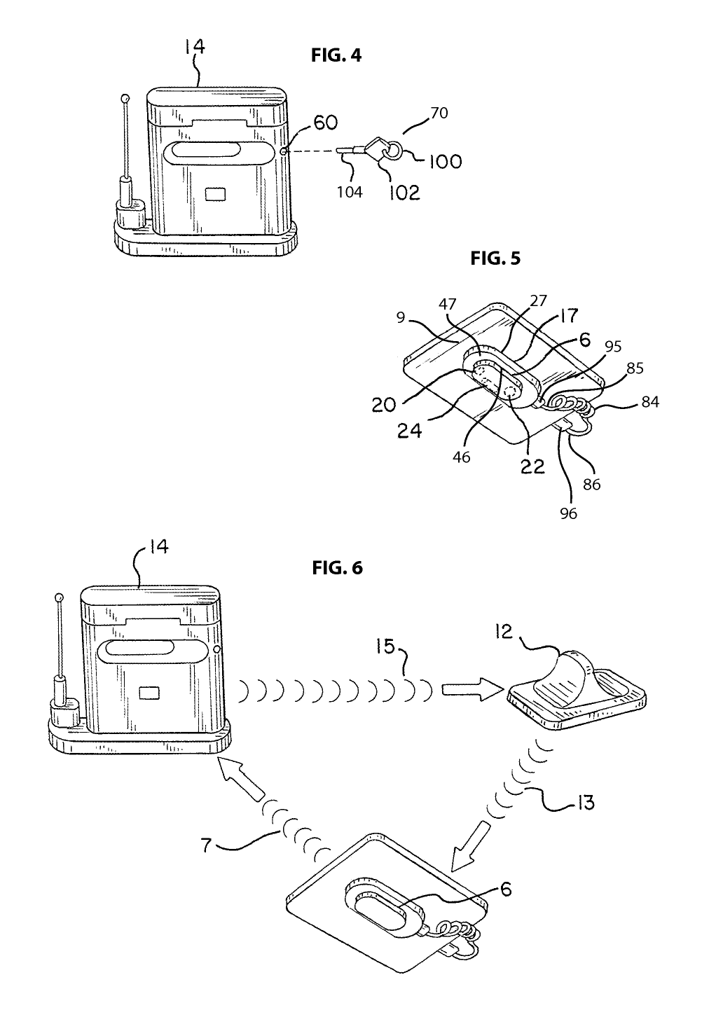

As illustrated in FIG. 4, the hub 14 may have a keyhole 80 that may be defined by an aperture 90 that may extend into the hub 14. The aperture 90 may be sized to receive a key 70 that may be used to disarm the first alarm and/or the second alarm. The key 70 may have a microchip (not shown) that may use radio frequency identification technology and/or may store a unique serial number associated with the key 70. The microprocessor 72 may be programmed to read the serial number that may be associated with the key 70. The microprocessor 72 may have a memory (not shown) that may store the serial number that may be associated with the key 70. The first alarm and/or the second alarm may be disarmed by inserting the key 70 into the keyhole 80. After inserting the key 70 into the keyhole 80, the microprocessor 72 may be programmed to recognize the serial number associated with the key 70 and/or may be programmed to disarm the first alarm and/or the second alarm. The light 40 and/or the speaker 42 may turn off when the key 70 may be inserted into the keyhole 80 of the hub 14.

Moreover, as illustrated in FIG. 4, the key 70 may have a barrel pin 104 that may be sized to fit into the aperture 90 of the keyhole 80. The microchip of the key 70 may be secured within and/or on the barrel tip 104. In addition, as illustrated in FIG. 4, the key 70 may have a key ring 100 and/or a handle 102 that may allow, for example, the retail store employee to carry the key 70.

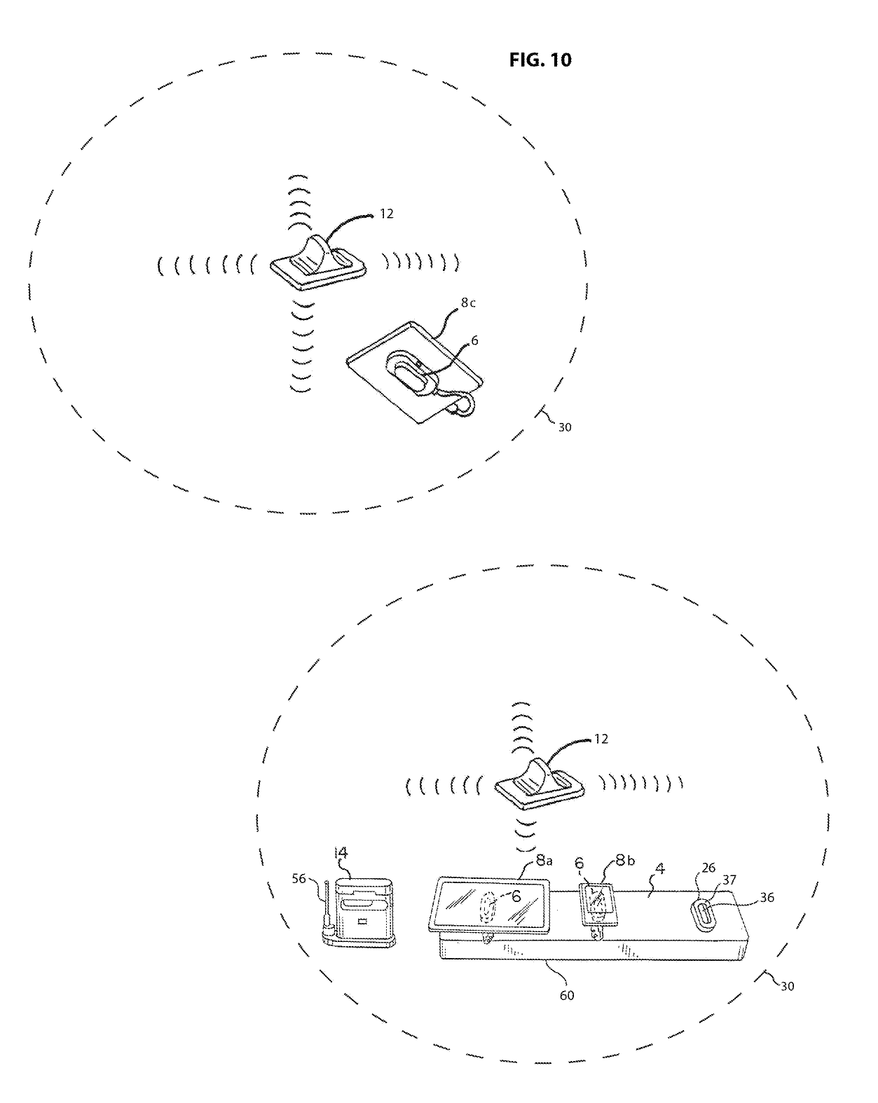

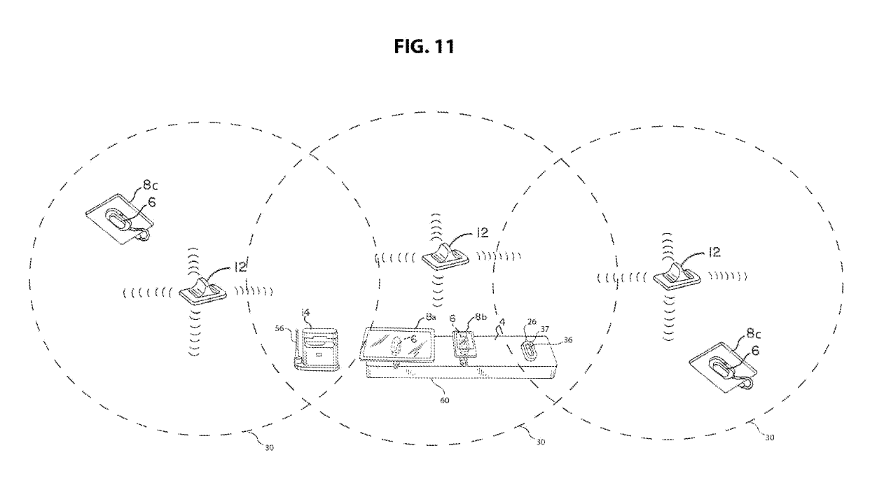

In an embodiment of the present invention, multiple emitters 12 may wirelessly communicate with the hub 14 to transmit radio signals that may establish multiple zones 30, as illustrated in FIGS. 10 and 11. The multiple zones 30 may extend from a corresponding one of the multiple emitters 12. Movement of the head 6 and/or the device 8 may be permitted within the multiple zones 30. As illustrated in FIG. 10, one or more of the multiple zones 30 may surround and/or be adjacent to the display 60 of the device 8. In addition, as illustrated in FIG. 10, one or more of the multiple zones 30 may not contact one or more of the multiple zones 30. The retail store employee may transfer the head 6 and/or the device 8 between one of the multiple zones that is not in contact with one of the multiple zones without triggering the first alarm and/or the second alarm. The key 70 may be inserted into the keyhole 80 of the hub 14 to deactivate the first alarm and/or the second alarm. While the first alarm and/or the second alarm are deactivated, for example, the retail store employee may remove the head 6 and/or the device from one or more of the multiple zones 30. Then, for example, the retail store employee may place the head 6 and/or the device 8 in another one or more of the multiple zones 30. To reactivate the first alarm and/or the second alarm, for example, the retail store employee may remove the key 70 from the keyhole 80 of the hub 14 to reactivate the first alarm and/or the second alarm.

In an embodiment of the present invention, the multiple emitters 12 may be arranged so that one or more of the multiple zones 30 may overlap and/or be adjacent to each other, as illustrated in FIG. 11. One or more of the multiple zones 30 may surround and/or be adjacent to the display 60. Movement of the head 6 and/or the device 8 may be permitted within the multiple zones 30. When the multiple zones 30 overlap and/or are adjacent to each other, movement of the head 6 and/or the device 8 may be permitted within a greater distance from the display 60 of the device 8 than within one of the multiple zones 30. Removing the head 6 and/or the device 8 from the multiple zones 30 may trigger the first alarm and/or the second alarm.

The head 6 and/or the device 8 may be docked on the display 60, for example, in a retail environment. The individual may use the device 8 within the zone 30. If the individual removes the head 6 and/or the device 8 from the zone 30, then the head 6 may trigger the first alarm. If the individual removes the head 6 and/or the device 8 from the zone 30 for the time that exceeds the threshold, then the hub 14 may trigger the second alarm. The second alarm may be disarmed using the key 70.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. An apparatus for monitoring a first device within a first zone wherein the first device is inside of the first zone in a first position and further wherein the first device is outside of the first zone in a second position, the apparatus comprising:
a first emitter within the first zone and having a first transmitter that transmits a first signal to establish the first zone that extends from the first emitter;
a first head secured to the first device wherein the first head wirelessly communicates with the first emitter wherein the first head has a first receiver that receives the first signal in the first position of the first device wherein the first head triggers a first alarm in the second position of the first device and further wherein the first head has a second transmitter that transmits a second signal in the second position of the first device; and
a hub that wirelessly communicates with the first emitter and the first head wherein the hub has a second receiver that receives the second signal and further wherein the hub triggers a second alarm in the second position of the first device.

2. The apparatus of claim 1 further comprising:
a light associated with the first head wherein the light emits a visible alert.

3. The apparatus of claim 1 further comprising:
a second emitter within a second zone and having a third transmitter that transmits a third signal to establish the second zone that extends from the second emitter wherein the first head and the hub wirelessly communicate with the second emitter.

4. The apparatus of claim 1 further comprising:
a key that inserts into the hub to deactivate the second alarm.

5. The apparatus of claim 1 further comprising:
a second head secured to a second device wherein the second head wirelessly communicates with the first emitter and the hub.

6. The apparatus of claim 1 further comprising:
a speaker in the hub wherein the speaker emits an audible alert.

7. The apparatus of claim 1 further comprising:
a cable having a length defined between a first end and a second end wherein the first end is connected to the first device and the second end is connected to the first head.

8. A system for monitoring a first device within a first zone wherein an alarm is triggered to indicate that the first device is removed to a position outside of the first zone, the system comprising:
a first emitter having a first receiver that receives a first signal and a first transmitter that transmits a second signal to establish the first zone that extends from the first emitter; and
a first head secured to the first device wherein the first head wirelessly communicates with the first emitter and receives the second signal and further wherein the first head triggers the first alarm.

9. The system of claim 8 further comprising:
a second head secured to a second device wherein the second head wirelessly communicates with the first emitter and receives the second signal and further wherein the second head triggers an alert indicative of the second device in a position outside of the first zone.

10. The system of claim 8 further comprising:
a hub that wirelessly communicates with the first emitter and the first head wherein the first head transmits a third signal to the hub and further wherein the third signal is indicative of the first device in the position outside of the first zone.

11. The system of claim 8 further comprising:
a cradle within the first zone and having a recess wherein the first head rests in the recess.

12. The system of claim 8 further comprising:
a second emitter having a second receiver and a second transmitter wherein the second emitter wirelessly communicates with the first head and establishes a second zone and further wherein the second zone intersects with the first zone.

13. The system of claim 8 further comprising:
a speaker in the first head wherein the speaker emits an audible alert.

14. A method for monitoring a device within a zone wherein the device wirelessly communicates with a first emitter and a hub and further wherein the zone surrounds the first emitter, the method comprising the steps of:
transmitting a first signal wirelessly from the hub to the first emitter;
transmitting a second signal wirelessly from the first emitter to define the zone;
detecting the device in a position exterior to the zone; and
triggering a first alarm upon detection of the device in the position exterior to the zone.

15. The method of claim 14 further comprising the step of:
deactivating the first alarm upon detection of the device in a position within the zone.

16. The method of claim 14 further comprising the step of:
transmitting a third signal wirelessly from the device to the hub wherein the third signal is indicative of a detection of the device in the position exterior to the zone.

17. The method of claim 14 further comprising the step of:
triggering a second alarm indicative of the device in the position exterior to the zone.

18. The method of claim 14 further comprising the step of:
disarming the second alarm by inserting a key into the hub.

19. The method of claim 14 further comprising the step of:
illuminating a light in response to triggering the first alarm.

20. The method of claim 14 further comprising the step of:
transmitting the first signal wirelessly from the hub to a second emitter that is in wireless communication with the hub and the device.
